(19) United States
(12) Patent Application Publication
(10) Pub. No.: US 2024/0405195 A1
(43) Pub. Date: Dec. 5, 2024

(54) ANODE FOR ALL-SOLID-STATE BATTERIES INCLUDING METAL NANOWIRES AND METHOD OF MANUFACTURING THE SAME

(71) Applicants: Hyundai Motor Company, Seoul (KR); Kia Corporation, Seoul (KR)

(72) Inventors: So Ri Lee, Changwon (KR); Gyeong Jun Chung, Daejeon (KR); Seung Hwan Moon, Hwaseong (KR); Sung Hoo Jung, Changwon (KR); Jong Jung Kim, Suwon (KR)

(21) Appl. No.: 18/242,992

(22) Filed: Sep. 6, 2023

(30) Foreign Application Priority Data
Jun. 2, 2023 (KR) 10-2023-0071237

(51) Int. Cl. H01M 4/134; H01M 4/04; H01M 4/1395; H01M 10/0562

(52) U.S. Cl. CPC H01M 4/134; H01M 4/0404; H01M 4/1395; H01M 10/0562; H01M 2004/027

(57) ABSTRACT

Disclosed are an anode for all-solid-state batteries which has a coating layer located on an anode current collector and including pores formed by entangling metal nanowires, and a method of manufacturing the same.

### CROSS-REFERENCE TO RELATED APPLICATION

This application claims under 35 U.S.C. § 119(a) the benefit of priority to Korean Patent Application No. 10-2023-0071237 filed on Jun. 2, 2023, the entire contents of which are incorporated herein by reference.

### TECHNICAL FIELD

The present disclosure relates to an anode for all-solid-state batteries which has a coating layer located on an anode current collector and including pores formed by entangling metal nanowires, and a method of manufacturing the same.

### BACKGROUND

An all-solid-state battery has excellent stability and high energy density, and thus has been receiving great attention. Electrodes of the all-solid-state battery have a form including an active material, a solid electrolyte, a conductive material, a binder, and the like.

Research on application of a silicon-based anode active material so as to increase the capacity of the all-solid-state battery is actively underway. However, the silicon-based anode active material undergoes great changes in volume during charging and discharging, and thus, detachment between the anode active material and an anode current collector may occur. Further, the silicon-based anode active material has a low electrical conductivity compared to a carbon-based anode active material and a metal-based anode active material, restricts migration of electrons during charging and discharging, and thus has poor charging and discharging efficiency.

In order to prevent detachment of the silicon-based anode active material due to such changes in the volume of the silicon-based anode active material, increase in the content of the binder may be considered. However, when the content of the binder increases, resistance of the anode increases, the contents of the anode active material and the solid electrolyte are relatively reduced, and thus, the capacity of the anode is reduced and the lithium ion conductivity of the anode is lowered.

In order to compensate for the low electrical conductivity of the silicon-based anode active material, increase in the content of the conductive material may be considered. However, when the content of the conductive material increases, the conductive material particles may aggregate, and thus, dispersibility of components in the anode may be decreased.

The above information disclosed in this Background section is only for enhancement of understanding of the background of the invention and therefore it may contain information that does not form the prior art that is already known in this country to a person of ordinary skill in the art.

### SUMMARY

In preferred aspects, the disclosure provides an anode for all-solid-state batteries which has excellent adhesive strength between an anode layer and an anode current collector and a method of manufacturing the same.

A term “all-solid-state battery” as used herein refers to a rechargeable secondary battery that includes an electrolyte in a solid state for transferring ions between the electrodes of the battery.

In one preferred aspect, provided is an anode for all-solid-state batteries which has excellent electrical conductivity and a method of manufacturing the same.

In one aspect, the present disclosure provides an anode suitable for all-solid-state batteries. The anode includes an anode current collector, a coating layer disposed on the anode current collector and including pores formed by metal nanowires, and an anode layer disposed on the coating layer and including an anode material.

In one aspect, the pores are formed by entangling the metal nanowires.

The coating layer may include a first layer configured to contact the anode current collector, and a second layer disposed on the first layer and configured such that the pores are filled with a portion of the anode material of the anode layer. For example, about 1 wt %, about 5 wt %, about 10 wt %, about 20 wt %, about 30 wt %, about 40 wt %, about 50 wt %, about 60 wt %, about 70 wt %, about 80 wt %, about 90 wt %, or about 95 wt % of the anode material of the anode layer may fill the pores of the coating layer.

The metal nanowires may suitably include nickel (Ni), copper (Cu), or a combination thereof.

The metal nanowires may suitably have a length of about 5 μm to 25 μm, and a diameter of about 10 nm to 50 nm.

A thickness of the anode layer may be greater than a thickness of the second layer.

The thickness of the anode layer may suitably be about 25 μm to 30 μm.

A thickness of the first layer may suitably be about 6 μm to 10 μm.

The thickness of the second layer may suitably be about 5 μm to 10 μm.

The anode material may include a silicon-based anode active material and a solid electrolyte.

In one aspect, the present disclosure provides a method of manufacturing an anode for all-solid-state batteries. The method includes steps of: preparing a solution including a precursor of metal nanowires, obtaining an intermediate by applying the solution to an anode current collector, obtaining a coating layer including pores formed by forming the metal nanowires on the anode current collector by heat-treating the intermediate, and forming an anode layer by applying slurry including an anode material to the coating layer.

The metal nanowires on the anode current collector may be formed in entangling state by heat-treating.

The solution may preferably be basic.

The solution may further include a reducing agent.

In obtaining the coating layer, the intermediate may be heat-treated at a temperature of equal to or higher than about 120° C. but lower than about 140° C.

The intermediate may be heat-treated for a time of longer than about 10 hours but equal to or shorter than about 12 hours.

Further, in one aspect, provided is an all-solid-state battery including the anode as described herein.

Also provided is a vehicle that includes the all-solid-state battery as described herein.

Other aspects f the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an exemplary all-solid-state battery according to an exemplary embodiment of the present disclosure; and

FIG. 2 shows an exemplary coating layer according to an exemplary embodiment of the present disclosure.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

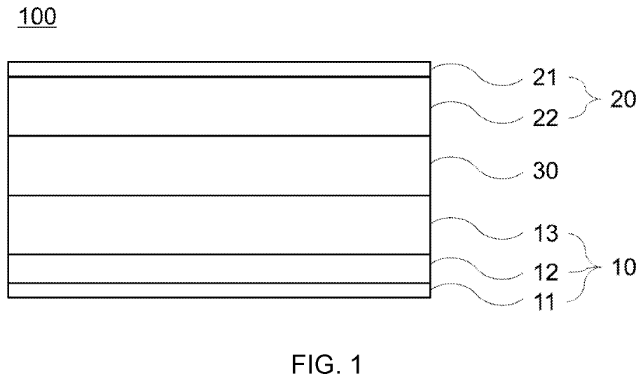

FIG. 1 shows an exemplary all-solid-state battery 100 according to an exemplary embodiment of the present disclosure. The all-solid-state battery 100 may include an anode 10, a cathode 20, and a solid electrolyte layer 30 interposed between the anode 10 and the cathode 20. Hereinafter, the respective components will be described in detail.

### Anode

The anode 10 may include an anode current collector 11, a coating layer 12 disposed on the anode current collector 11, and an anode layer 13 disposed on the coating layer 12 and including an anode material.

The anode current collector 11 may preferably be a plate-shaped base material having electrical conductivity. For example, the anode current collector 11 may take the form of a sheet, thin film or foil.

The anode current collector 11 may include a material which does not react with lithium.

Preferably, the anode current collector 11 may suitably include nickel (Ni), copper (Cu), stainless steel, or combinations thereof.

The thickness of the anode current collector 11 is not limited to a specific value, and may be, for example, about 1 μm to 500 μm.

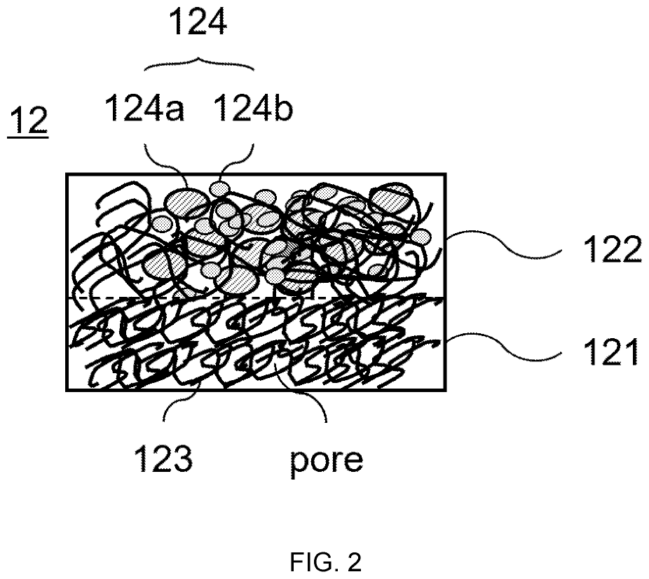

FIG. 2 shows an exemplary coating layer 12 according to an exemplary embodiment of the present disclosure. The coating layer 12 may include pores formed by entangling metal nanowires 123. The coating layer 12 may include a mesh structure in which the metal nanowires 123 are entangled.

The coating layer 12 may be formed by randomly entangling the metal nanowires 123, and thus has a large specific surface area and excellent electrical conductivity.

The coating layer 12 may include a first layer 121 configured to contact the anode current collector 11 and including the pores.

The first layer 121 has increased specific surface area, and has thus increased contact area with the anode current collector 11 and excellent adhesive strength to the anode current collector 11. Therefore, the content of a binder in the anode layer 13 may be reduced, resistance in the anode 10 may be decreased, and detachment of the anode active material 13 due to volume expansion of a silicon-based anode active material in the anode active material 13 may be prevented.

The coating layer 12 may include a second layer 122 disposed on the first layer 121 and configured such that the pores are filled with a part of an anode material 124 of the anode layer 13. The anode material 124 may include a silicon-based anode active material 124a, a solid electrolyte 124b, and the like.

Because the metal nanowires 123 and the anode material 124 are mixed in the second layer 122, the second layer 122 may improve electrical conductivity of the anode 10. Therefore, the content of a conductive material in the anode layer 13 may be reduced, and the resistance of the anode 10 may be reduced.

The metal nanowires 124 may suitably include nickel (Ni), copper (Cu), or a combination thereof.

The metal nanowires 124 may have a length of about 5 μm to 25 μm, and a diameter of about 10 nm to 50 nm. The diameter of the metal nanowires 124 may indicate the diameter of the cross section of the metal nanowires 124 when the metal nanowires 124 are cut in a direction vertical to the length direction of the metal nanowires 124. When the length of the metal nanowires 124 is less than about 5 μm, the coating layer 12 may have difficulty maintaining the structure thereof, and, when the length of the metal nanowires 124 is greater than about 25 μm, the metal nanowires 124 aggregate, the specific surface of the second layer 122 may be reduced, no pores are formed, and thus, the second layer 122 may not be filled with the anode material 124.

The anode layer 13 may include an anode material.

The anode material may include a silicon-based anode active material, a solid electrolyte, a conductive material, a binder, and the like.

The silicon-based anode active material may include Si, SiOₓ (0<x<2), or a combination thereof. Further, the silicon-based anode active material may further include a carbonaceous material. For example, the silicon-based anode active material may be acquired by coating cores including a silicon compound with a carbonaceous material, or may be acquired by coating cores including a carbonaceous material with a silicon compound.

The solid electrolyte may include a sulfide-based solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂Si₂, or the like.

The conductive material may include carbon black, conductive graphite, ethylene black, graphene, or the like.

The binder may include styrene butadiene rubber, nitrile butadiene rubber, butadiene rubber, polyvinylidene fluoride, polytetrafluoroethylene, or the like.

The thickness of the anode layer 13 may be greater than the thickness of the second layer 122. When the thickness of the anode layer 13 is less than the thickness of the second layer 122, the metal nanowires 124 of the second layer 122 may penetrate the anode layer 13 and the solid electrolyte layer 30 and thus a short circuit may occur, and the content of the anode material in the anode 10 may be reduced and thus the energy density and capacity of the anode 10 may be reduced.

Particularly, the thickness of the anode layer 13 may be about 25 μm to 30 μm. The thickness of the first layer 121 may be about 6 μm to 10 μm. The thickness of the second layer 122 may be about 5 μm to 10 μm.

A method of manufacturing the anode 10 may include steps of: preparing a solution including a precursor of the metal nanowires 123, obtaining an intermediate by applying the solution to the anode current collector 11, obtaining the coating layer 12 including the pores formed by forming the metal nanowires 123 on the anode current collector 11 by heat-treating the intermediate, and forming the anode layer 13 by applying slurry including the anode material to the coating layer 12. The metal nanowires 123 may be formed in entangling state by heat-treating.

The precursor of the metal nanowires 123 may include an oxide or a sulfide of nickel, copper, or the like. The precursor of the metal nanowires 123 may include NiC₂O₄, NiSO₄, CuC₂O₄, CuSO₄, or the like.

The solution may be prepared by dissolving the precursor of the metal nanowires 123 in a solvent, such as an acid, water, or the like.

The solution may be basic. For example, the pH of the solution may be greater than about 7 but equal to or less than about 14. The solution may be made basic by adding NaOH, NH₃, NH₄OH, or the like thereto.

The solution may further include a reducing agent. The reducing agent may include N₂H₄, or the like.

The intermediate may be acquired by applying the solution to the anode current collector 11. Application of the solution is not limited to a specific method, and may be executed using a spin coating method, a spray coating method, a deep coating method, or the like.

Thereafter, the coating layer 12 may be formed by reducing the precursor of the metal nanowires 123 by heat-treating the intermediate.

Particularly, the coating layer 12 may be formed by heat-treating the intermediate at a temperature of equal to or higher than about 120° C. but lower than about 140° C. When the heat treatment temperature is lower than 120° C., the precursor is not reduced and thus the metal nanowires 123 may not be formed, and, when the heat treatment temperature is equal to or higher than 140° C., the metal nanowires 123 aggregate and thus the coating layer 12 may not be adhered to the anode current collector 11.

Further, the coating layer 12 may be formed by heat-treating the intermediate for a time of longer than about 10 hours but equal to or shorter than about 12 hours. When the heat treatment time is equal to or shorter than 10 hours, the amount of reduction of the precursor is not sufficient and thus the coating layer 12 may not be properly formed, and, when the heat treatment time is longer than 12 hours, the amount of reduction of the precursor is excessively large and metal nanoparticles other than the metal nanowires 123 may be formed.

Thereafter, the pores in the coating layer 12 may be filled with a part of the anode material and the anode layer 13 may be formed on the coating layer 12 by applying the slurry including the anode material to the coating layer 12.

Finally, manufacture of the anode 10 may be completed by drying the anode current collector 11, the coating layer 12, and the anode layer 13.

### Cathode

The cathode 20 may include a cathode current collector 21, and a cathode active material layer 22 disposed on the cathode current collector 21.

The cathode current collector 21 may include a plate-shaped base material having electrical conductivity. The cathode current collector 21 may include aluminum foil.

The thickness of the cathode current collector 21 is not limited to a specific value, and may be, for example, about 1 μm to 500 μm.

The cathode active material layer 22 may include a cathode active material, a solid electrolyte, a conductive material, a binder, and the like.

The cathode active material may store and release lithium ions.

The cathode active material may include a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The solid electrolyte may include an oxide-based solid electrolyte or a sulfide-based solid electrolyte.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The conductive material may include carbon black, conductive graphite, ethylene black, graphene, or the like. The conductive material included in the cathode active material layer 22 may be the same as or different from the conductive material included in the anode layer 13.

The binder may include butadiene rubber, nitrile butadiene rubber, hydrogenated nitrile butadiene rubber, polyvinylidene fluoride, polytetrafluoroethylene, or the like. The binder included in the cathode active material layer 22 may be the same as or different from the binder included in the anode layer 13.

### Solid Electrolyte Layer

The solid electrolyte layer 30 may be interposed between the anode 10 and the cathode 20, and may include a solid electrolyte having lithium ion conductivity.

The solid electrolyte may include an oxide-based solid electrolyte or a sulfide-based solid electrolyte.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The solid electrolyte included in the solid electrolyte layer 30 may be the same as or different from the solid electrolyte included in the cathode active material layer 22.

### EXAMPLE

Hereinafter, the present disclosure will be described in more detail through the following examples. The following examples serve merely to exemplarily describe the present disclosure, and are not intended to limit the scope of the invention.

### Example 1

A solution was prepared by dissolving NiSO₄, which is a precursor of metal nanowires, in water, injecting sodium hydrate (NaOH) thereinto so as to adjust the pH of the solution to greater than 7, and then injecting N₂H₄, which is a reducing agent, thereinto.

An intermediate was obtained by applying the solution to nickel foil serving as an anode current collector.

The precursor was reduced by heat-treating the intermediate at a temperature of 120° C. for 11 hours, and consequently, a coating layer including pores formed by entangling the metal nanowires was obtained.

An anode active material and a solid electrolyte were put into a planetary disperser (PD) mixer, and were dry-mixed. A slurry was acquired by adding a binder, a dispersant, and a solvent to a resultant product, and mixing the same. An anode layer was formed by applying the slurry to the coating layer using a blade and then drying the slurry at a temperature of about 90° C.

An anode was manufactured by vacuum-drying a stack including the anode current collector, the coating layer and the anode layer at a temperature of about 120° C. for about 4 hours.

### Example 2

An anode was manufactured in the same manner as in Example 1, except that the intermediate was heat-treated for 12 hours.

### Example 3

An anode was manufactured in the same manner as in Example 1, except that the intermediate was heat-treated at a temperature of 130° C.

### Example 4

An anode was manufactured in the same manner as in Example 1, except that the intermediate was heat-treated at a temperature of 130° C. for 12 hours.

### COMPARATIVE EXAMPLE

An anode including no coating layer was manufactured. An anode layer was prepared by applying the slurry of Example 1 directly to nickel foil serving as an anode current collector, and then drying the slurry at a temperature of about 90° C.

The anode was manufactured by vacuum-drying a stack including the anode current collector and the anode layer at a temperature of about 120° C. for about 4 hours.

Adhesive strengths and resistances of the anodes according to Examples 1 to 4 and Comparative Example were evaluated. Results of evaluation are set forth in Table 1 below.

The adhesive strength of each of the anodes according to Examples 1 to 4 means adhesive strength between the coating layer and the anode current collector, and the adhesive strength of the anode according to Comparative Example means adhesive strength between the anode layer and the anode current collector.

The adhesive strength of each of the respective anodes was measured using a 1800 peel strength tester by a method as follows.
Preparation of test specimens: A piece having a size 25 mm×150 mm was cut out from each of the anodes, and was adhered to a slide glass (25 mm×75 mm).
Test: Each specimen, in which only a half of the anode was adhered to the slide glass, was fixed to the lower end of the tester, and was turned 180 degrees upside down. The anode was fixed to the upper end of the tester and was pulled at a speed of 30 mm/min, and the value of applied force was measured.
Results: Average adhesive strength was derived by dividing force (gf) applied in a section of 20 mm to 40 mm by the width, i.e., 25 mm.

The resistance of each of the respective anodes was measured using an electrode resistance measurement system. The electrode resistance measurement system is equipment which calculates resistance based on a voltage value measured when a specimen is placed on a measurement part with probes and then current is applied thereto. Measurement conditions were as follows.

### <Measurement Conditions>

Current: 10 mA
Voltage range: within 0.5 V

TABLE 1

| | | | Electrode evaluation | |
|---|---|---|---|---|
| | Heat treatment conditions | | Adhesive | |
| | Temperature | Time | strength | Resistance |
| Category | [° C.] | [hr] | [gf/mm] | [Ω · cm²] |
| Example 1 | 120 | 11 | 0.56 | 2.13 × 10⁻² |
| Example 2 | 120 | 12 | 0.73 | 2.05 × 10⁻² |
| Example 3 | 130 | 11 | 0.38 | 2.89 × 10⁻² |
| Example 4 | 130 | 12 | 0.33 | 2.48 × 10⁻² |
| Comparative | — | — | 0.34 | 6.47 × 10⁻² |
| example | | | | |

As shown in Table 1 above, it may be confirmed that the resistances of the anodes including the coating layer according to Examples 1 to 4 were much less than the resistance of the anode according to Comparative Example. Further, the adhesive strengths of the anodes according to Examples 1 and 2 were excellent compared to the anode according to Comparative Example. Therefore, when the coating layer including the pores formed by entangling the metal nanowires according to various exemplary embodiments of the present disclosure was interposed between the anode current collector and the anode layer, resistance of the anode could be reduced, and adhesive strength between the respective layers could be increased.

As is apparent from the above description, according to the present disclosure, an anode for all-solid-state batteries which has excellent adhesive strength between an anode layer and an anode current collector, and a method of manufacturing the same may be provided.

According to the present disclosure, an anode for all-solid-state batteries which has excellent electrical conductivity, and a method of manufacturing the same may be provided.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An anode for an all-solid-state battery, comprising:
an anode current collector;
a coating layer i) disposed on the anode current collector and ii) comprising pores formed by metal nanowires; and
an anode layer disposed on the coating layer and comprising an anode material,
wherein the coating layer comprises a mesh structure in which the metal nanowires are entangled,
wherein the coating layer comprises:
a first layer configured to contact the anode current collector; and
a second layer disposed on the first layer and configured such that the pores are filled with a at least a portion of the anode material of the anode layer.

2. The anode of claim 1, wherein the metal nanowires comprise nickel (Ni), copper (Cu), or a combination thereof.

3. The anode of claim 1, wherein the metal nanowires have a length of about 5 μm to 25 μm, and a diameter of about 10 nm to 50 nm.

4. The anode of claim 1, wherein a thickness of the anode layer is greater than a thickness of the second layer.

5. The anode of claim 1, wherein a thickness of the anode layer is about 25 μm to 30 μm.

6. The anode of claim 1, wherein a thickness of the first layer is about 6 μm to 10 μm.

7. The anode of claim 1, wherein a thickness of the second layer is about 5 μm to 10 μm.

8. The anode of claim 1, wherein the anode material comprises a silicon-based anode active material and a solid electrolyte.

9. A method of manufacturing an anode for all-solid-state batteries, comprising:
preparing a solution comprising a precursor of metal nanowires;
obtaining an intermediate by applying the solution to an anode current collector;
obtaining a coating layer comprising pores formed by forming metal nanowires on the anode current collector by heat-treating the intermediate; and
forming an anode layer by applying slurry comprising an anode material to the coating layer,
wherein the coating layer comprises:
a first layer configured to contact the anode current collector; and
a second layer disposed on the first layer and configured such that the pores are filled with a portion of the anode material of the anode layer.

10. The method of claim 9, wherein the solution is basic.

11. The method of claim 9, wherein the solution further comprises a reducing agent.

12. The method of claim 9, wherein, in obtaining the coating layer, the intermediate is heat-treated at a temperature of equal to or higher than about 120° C. but lower than about 140° C.

13. The method of claim 9, wherein, in obtaining the coating layer, the intermediate is heat-treated for a time of longer than about 10 hours but equal to or shorter than about 12 hours.

14. The method of claim 9, wherein the metal nanowires comprise nickel (Ni), copper (Cu), or a combination thereof.

15. The method of claim 9, wherein the metal nanowires have a length of about 5 μm to 25 μm, and a diameter of about 10 nm to 50 nm.

16. The method of claim 9, wherein a thickness of the anode layer is greater than a thickness of the second layer.

17. The method of claim 9, wherein a thickness of the anode layer is about 25 μm to 30 PM.

18. The method of claim 9, wherein a thickness of the first layer is about 6 μm to 10 μm.

19. The method of claim 9, wherein a thickness of the second layer is about 5 μm to 10 μM.

20. The method of claim 9, wherein the anode material comprises a silicon-based anode active material and a solid electrolyte.
